(19) United States
(12) Patent Application Publication
(10) Pub. No.: US 2006/0077420 A1
(43) Pub. Date: Apr. 13, 2006

(54) Image forming apparatus, image forming system and relaying apparatus

(75) Inventors: Yuji Okamoto, Souraku-gun (JP); Katsuyoshi Fujiwara, Sennan-gun (JP); Naofumi Ueda, Souraku-gun (JP); Syouichirou Yoshiura, Ikoma-gun (JP)

Correspondence Address: EDWARDS & ANGELL, LLP, P.O. BOX 55874, BOSTON, MA, 02205, US

(73) Assignee: Sharp Kabushiki Kaisha

(21) Appl. No.: 11/229,420

(22) Filed: Sep. 16, 2005

(30) Foreign Application Priority Data
Sep. 22, 2004 (JP) JP2004-276046

(51) Int. Cl. G06K 15/00

(52) U.S. Cl. 358/1.14

(57) ABSTRACT

An image forming apparatus which accepts a job that includes image data and requires image formation on the basis of the image data, and which carries out image formation by carrying out a job that has been accepted is provided with: a means for determining whether or not the confidentiality of image data that is included in a job that has been accepted should be protected; a means for determining whether or not a process for protecting the confidentiality of the above described image data can be implemented, in the case where it has been determined that the confidentiality should be protected; and a means for reporting, in the case where it has been determined that the above described process cannot be implemented, to that effect.

### CROSS-REFERENCE TO RELATED APPLICATIONS

This Nonprovisional application claims priority under 35 U.S.C. § 119(a) on Patent Application No. 2004-276046 filed in Japan on Sep. 22, 2004, the entire contents of which are hereby incorporated by reference.

### BACKGROUND OF THE INVENTION

1. Field of the Invention

The present invention relates to an image forming apparatus, an image forming system and a relaying apparatus which can achieve an increase in the confidentiality.

2. Description of Related Art

Image forming apparatuses, such as multifunctional digital systems, for temporarily storing electronic data of documents in a memory within the apparatus and processing such data have been commercially produced. Multifunctional digital systems are provided with a scanner unit for reading images of manuscripts and a printer unit for forming an image on a sheet of paper, and have a number of functions, such as copying functions, facsimile functions, scanner functions and printing functions. Such multifunctional digital systems provide an increase in the operating efficiency and processing performance, by being placed on a communication network as a data processing apparatus for efficiently processing data that is inputted from a number of interfaces. In addition, a memory unit of a large capacity, such as a hard disk, is mounted on a multifunctional digital system, into which a variety of data is inputted, so that it becomes possible to process this data in parallel, in a manner where a number of requests for processing data are accepted, and making it possible to sequentially process the data.

This memory unit such as a hard disk is in a state where data is temporarily written in and stored for processing. Thus, the unit has a configuration where the data that has already been processed is overwritten, so that new data is accepted, in the case where new data is inputted after the completion of processing, and therefore, data after processing is left as it is within the unit, until new data is written in, causing a problem, from the point of view of data protection. In contrast, units have been proposed in recent years, which automatically delete or invalidate data which has been completely processed, so that data which is left within the unit does not become a problem (see, for example, Japanese Patent Application Laid Open No. 09-284572).

In addition, image forming apparatuses on which a document filing function is provided have also been proposed, so that image data that is developed from a print job can be stored in a memory unit such as a hard disk. In such an image forming apparatus, user identification is carried out when image data that has been stored in the memory unit is read out, preventing a third party from taking out the image data without authorization (see, for example, Japanese Patent Application Laid Open No. 07-28365). Furthermore, an image formation apparatus which encrypts image data that is stored in the memory unit in order to make it difficult to decode the image data even if the image data is taken out by a third party, has also been proposed (see, for example, Japanese Patent Application Laid Open No. 01-256068).

In the case where the above described security process, for example, a deletion process, encryption process or a using identification process, is carried out for all of the print jobs that have been accepted in the image forming apparatus, such a process is carried out on data of which the confidentiality is low, causing a problem where efficiency in the process is lowered. Therefore, the user himself/herself can arbitrarily set whether or not a deletion process is required, whether or not an encryption process is required, or whether or not a user identification process is required, and thus, the security process is carried out in the image forming apparatus only in the case where any of these processes has been set.

Even in the case where the user requests a deletion process, an encryption process, a user identification process or the like, however, in some cases, such a process may not be implemented, depending on the state of the setting or the state of operation on the image forming apparatus side. In the case where such a process is invalidated in the software as a result of the operation of the image forming apparatus, the image forming apparatus cannot implement such a process, even when a print job which requires a security process has been accepted. In addition, in the same manner, a security process cannot be carried out in the image forming apparatus, also in the case where the hardware which implements a deletion process, an encryption process, a user identification process or the like has stopped its operation or has been removed by a malicious third party without authorization. As a result of this, a problem arises, where the level of protection of confidentiality is lowered in the image forming apparatus, in that data can be leaked.

### BRIEF SUMMARY OF THE INVENTION

The present invention is provided in view of the above described situation, and an object of the invention is to provide an image forming apparatus of which the configuration allows for determination as to whether or not the confidentiality of image data that is included in an accepted job should be protected, whether or not a process for protecting the confidentiality can be performed in the case where it has been determined that the confidentiality should be protected, and, in the case where it is determined that the process cannot be performed, reporting to that effect, and thereby, a job is not accepted in the case where the level of protection of confidentiality is lowered, and thus, the level of protection of confidentiality can be maintained constant.

Another object of the present invention is to provide an image forming system and a relaying apparatus of which the configuration allows for determination as to whether or not the relaying apparatus determines whether or not the confidentiality of image data that is included in a job should be protected, in the case where this relaying apparatus receives has received the job that has been transmitted from a transmission apparatus, and searching for an image forming apparatus that can protect the confidentiality and notifying the transmission apparatus of the search result, in the case where it has been determined that the confidentiality should be protected, and thereby, the level of protection of confidentiality can be maintained constant in the system, even in the case where the level of protection of confidentiality in the image forming apparatus that forms the system has been lowered.

An image forming apparatus according to the present invention is an image forming apparatus which accepts a job that includes image data and requires image formation based on the image data, and which performs image formation by performing the accepted job, comprising a controller capable of performing operations of judging whether or not the confidentiality of image data included in an accepted job is to be protected; judging whether or not a process for protecting the confidentiality of the image data can be performed, when the confidentiality is judged to be protected; and when it is judged that the process cannot be performed, notifying the judgment result.

According to the present invention, whether or not the confidentiality of image data that is included in an accepted job should be protected is determined, and whether or not a process for protecting the confidentiality can be implemented is determined in the case where it has been determined that the confidentiality should be protected, and in the case where it has been determined that the implementation is impossible, this is reported, and therefore, in the case where the situation does not allow a process for protecting confidentiality to be implemented, the user is notified before the job is carried out.

The image forming apparatus according to the present invention is characterized in that said job includes information concerning whether or not the confidentiality of image data is to be protected, and a judgment is made as to whether the confidentiality of the image data is to be protected, based on said information.

According to the present invention, information concerning whether or not protection of the confidentiality of the image data is required is included in the job, and whether or not the confidentiality of the image data should be protected is determined on the basis of this information, and therefore, the intention of the user in terms of whether or not protection of confidentiality is required can be faithfully reflected.

The image forming apparatus according to the present invention is characterized in that said controller further capable of performing an operation of detecting the existence of a protective device for protecting the confidentiality of the image data, wherein a judgment is made as to whether the process can be performed, based on the detected result.

According to the present invention, a means for detecting whether or not a protecting means for protecting the confidentiality of the image data exists is provided, and whether or not the process for protecting the confidentiality can be implemented is determined on the basis of the detection result of the means, and therefore, even in the case where the user requires a confidentiality process, the user is notified that the confidentiality process cannot be implemented in the case where no protecting means is provided.

The image forming apparatus according to the present invention is provided with a protecting means for protecting the confidentiality of the above described image data a protective device for protecting the confidentiality of the image data, wherein said controller further capable of performing an operation of detecting the operating conditions of the protective device, and a judgment is made as to whether the process can be performed, based on the detected result.

According to the present invention, a means for detecting the state of operation of a protective means for protecting the confidentiality of image data is provided, and whether or not a process for protecting the confidentiality can be implemented is determined on the basis of the detection result of the means, and therefore, even in the case where the user requires a confidentiality process, the user is notified that the confidentiality process cannot be implemented in the case where no protecting means is provided.

The image forming apparatus according to the present invention is characterized in that the process is a process for encrypting the image data.

According to the present invention, encryption of image data is carried out as a process for protecting the confidentiality of image data, and therefore, in the case where the user requires protection of confidentiality and a process for protecting confidentiality can be implemented in the image forming apparatus, encryption of image data is carried out.

The image forming apparatus according to the present invention is characterized in that the process is a process for deleting the image data after the completion of image formation based on the image data.

According to the present invention, image data is deleted as a process for protecting the confidentiality of image data after image formation has been carried out, and therefore, in the case where the user requires protection of confidentiality and a process for protecting the confidentiality can be implemented in the image forming apparatus, image data is deleted after image formation has been carried out on the basis of the job.

The image forming apparatus according to the present invention is characterized in that the process is a process for identifying a user when performing image formation based on the image data.

According to the present invention, identification of the user is carried out at the time of image formation, as a process for protecting the confidentiality of image data, and therefore, the identification of the user is carried out at the time of image formation in the case where the user requires protection of confidentiality, and a process for protecting the confidentiality can be implemented in the image forming apparatus.

The image forming apparatus according to the present invention is characterized in that the process is a process for storing a history of a job that has been accepted.

According to the present invention, the history of accepted jobs is stored as a process for protecting the confidentiality of image data, and therefore, the history of the accepted jobs is recorded in the case where the user requires protection of confidentiality and the process for protecting confidentiality can be implemented in the image forming apparatus.

An image forming system according to the present invention is an image forming system comprising; a transmitting apparatus; a relaying apparatus; and an image forming apparatus; wherein said transmitting apparatus comprises; a transmitting section for transmitting a job that includes image data and requires image formation based on the image data to said image forming apparatus via said relaying apparatus, said image forming apparatus comprises; a receiving section for receiving a job that is transmitted from said transmitting apparatus; an image forming section for performing image formation by performing the received job; and a transmitting section for transmitting information concerning the configuration of the apparatus to said relaying apparatus, and said relaying apparatus comprises; a receiving section for receiving information that is transmitted from said image forming apparatus, and a job that is transmitted from said transmitting apparatus; and a controller capable of performing operations of: judging whether or not the confidentiality of image data included in a received job is to be protected; judging whether or not a process for protecting the confidentiality of the image data can be performed, when the confidentiality is judged to be protected; and when it is judged that the process cannot be performed, transmitting the judgment result to said transmitting apparatus.

According to the present invention, in the case where the relaying apparatus receives a job that has been transmitted from the transmission apparatus, this relaying apparatus determines whether or not the confidentiality of image data that is included in the job should be protected, and in the case where it has been determined that the confidentiality should be protected, whether or not a process for protecting the confidentiality can be implemented is determined, and in the case where it has been determined that implementation is impossible, the transmission apparatus is notified to that effect, and therefore, the user is notified, before the job is carried out under the circumstances where the process for protecting confidentiality cannot be implemented.

An image forming system according to the present invention is an image forming system comprising; a transmitting apparatus; a relaying apparatus; and a plurality of image forming apparatuses; wherein said transmitting apparatus comprises; a transmitting section for transmitting a job that includes image data and requires image formation based on the image data to the image forming apparatus via said relaying apparatus, said image forming apparatus comprises; a receiving section for receiving a job that is transmitted from said transmitting apparatus; an image forming section for performing image formation by performing the received job; and a transmitting section for transmitting information concerning the configuration of the apparatus to said relaying apparatus, and said relaying apparatus comprises; a receiving section for receiving information that is transmitted from each image forming apparatus, and a job that is transmitted from said transmitting apparatus; and a controller capable of performing operations of: judging whether or not the confidentiality of image data included in a received job is to be protected; searching for an image forming apparatus where protection of the confidentiality of the image data is possible, when the confidentiality is judged to be protected; and notifying said transmitting apparatus of the searched result.

According to the present invention, in the case where the relaying apparatus receives a job that has been transmitted form the transmission apparatus, this relaying apparatus determines whether or not the confidentiality of image data that is included in the job should be protected, and in the case where it has been determined that the confidentiality should be protected, an image forming apparatus where protection of confidentiality is possible is searched for, and the transmission apparatus is notified of the search result, and therefore, in the case where an image forming apparatus which can implement a process concerning protection of confidentiality is connected to the relaying apparatus, the origin of transmission is notified of the job information on this information forming apparatus, and thus, the level of protection of confidentiality in the system can be maintained constant.

The image forming system according to the present invention is characterized in that said job includes information concerning whether or not the confidentiality of image data is to be protected, and a judgment is made as to whether the confidentiality of the image data is to be protected, based on said information.

According to the present invention, information concerning whether or not protection of the confidentiality of image data is required is included in the job, and whether or not the confidentiality of image data should be protected is determined on the basis of this information, and therefore, the intention of the user in terms of whether or not protection of confidentiality is required can be faithfully reflected.

The image forming system according to the present invention is characterized in that the information concerning the configuration of the apparatus includes information concerning the existence of a protective device for protecting the confidentiality of the image data.

According to the present invention, the information concerning the apparatus configuration includes information concerning the existence of a means for protecting the confidentiality of image data, and therefore, whether or not a process for protecting the confidentiality can be implemented is determined, on the basis of this information.

The image forming system according to the present invention is characterized in that the information concerning the configuration of the apparatus includes information concerning the operating conditions of a protective device for protecting the confidentiality of the image data.

According to the present invention, the information concerning the apparatus configuration includes information concerning the state of operation of a means for protecting the confidentiality of image data, and therefore, whether or not a process for protecting the confidentiality is possible is determined, on the basis of this information.

A relaying apparatus according to the present invention is a relaying apparatus comprising; a connecting section for connecting an image forming apparatus; a receiving section for receiving a job that includes image data and requires image formation based on the image data, and information concerning the configuration of an image forming apparatus that is connected to the connecting section; a transmitting section for transmitting a received job to the image forming section; a controller capable of performing operations of judging whether or not the confidentiality of image data included in a received job is to be protected; judging whether or not a process for protecting the confidentiality of the image data can be performed, when the confidentiality is judged to be protected; and when it is judged that the process cannot be performed, transmitting the judgment result to the origin of the transmission of the job.

According to the present invention, in the case where a job that has been transmitted from a transmission apparatus is received, whether or not the confidentiality of image data that is included in this job should be protected is determined, and in the case where it has been determined that the confidentiality should be protected, whether or not a process for protecting the confidentiality can be implemented is determined, and in the case where it has been determined that implementation is impossible, the transmission apparatus is notified to that effect, and therefore, the user is notified before the job is carried out, under the circumstances where the process for protecting the confidentiality cannot be implemented.

A relaying apparatus according to the present invention is a relaying apparatus comprising; a connecting section for connecting a plurality image forming apparatuses; a receiving section for receiving a job that includes image data and requires image formation based on the image data, and information concerning the configuration of image forming apparatuses that are connected to the connecting section; a transmitting section for transmitting a received job to an image forming section; a controller capable of performing operations of judging whether or not the confidentiality of image data included in a received job is to be protected; searching for an image forming apparatus where protection of the confidentiality of the image data is possible, when the confidentiality is judged to be protected; and notifying the origin of the transmission of the job of the searched result.

According to the present invention, in the case where a job that has been transmitted from a transmission apparatus is received, whether or not the confidentiality of image data that is included in this job should be protected is determined, and in the case where it has been determined that the confidentiality should be protected, an image forming apparatus where protection of the confidentiality is possible is searched, and the transmission apparatus is notified of the search result, and therefore, in the case where an image forming apparatus that can implement a process concerning protection of confidentiality is connected to the relaying apparatus, the origin of transmission of the job is notified of the information on this image forming apparatus, and thus, the level of protection of the confidentiality in the system can be maintained constant.

According to the present invention, whether or not the confidentiality of image data that is included in an accepted job should be protected is determined, and in the case where it has been determined that the confidentiality should be protected, it is determined whether or not a process for protecting the confidentiality can be implemented, and in the case where it has been determined that implementation is impossible, this is reported to the user. Accordingly, the user is notified before the job is carried out, under the circumstances where a process for protecting the confidentiality cannot be implemented, and thereby, the user can determine whether or not the job should be carried out on the basis of this notification.

According to the present invention, information concerning whether or not protection of the confidentiality of image data is required is included in the job, and whether or not the confidentiality of image data should be protected is determined on the basis of this information. Accordingly, the intention of the user in terms of whether or not protection of confidentiality is required can be faithfully reflected, and the level of protection of the confidentiality can be maintained constant.

According to the present invention, a means for detecting the existence of a protecting means for protecting the confidentiality of image data is provided, and whether or not it is possible to implement a process for protecting the confidentiality is determined on the basis of this detection result. Accordingly, even in the case where the user requires a confidentiality process, the user is notified that the confidentiality process cannot be implemented, and the user can cancel the job, if necessary, or change the destination of transmission of the job, in the case where the protecting means is not provided.

According to the present invention, a means for detecting the state of operation of a protecting means for protecting the confidentiality of image data is provided, and whether or not the process for protecting the confidentiality can be implemented is determined on the basis of this detection result. Accordingly, even in the case where the user requires a confidentiality process, the user is notified that the confidentiality process cannot be implemented, and the user can cancel the job, if necessary, or change the destination of transmission of the job, in the case where the protecting means is not provided.

According to the present invention, encryption of image data is carried out as a process for protecting the confidentiality of image data. Accordingly, in the case where the user requires protection of confidentiality and the process for protecting the confidentiality can be implemented in the image forming apparatus, encryption of image data is carried out, and protection of confidentiality can be achieved.

According to the present invention, image data is deleted as a process for protecting the confidentiality of image data, after image formation has been carried out. Accordingly, in the case where the user requires protection of confidentiality and a process for protecting the confidentiality can be implemented in the image forming apparatus, image data is deleted after image formation has been carried out on the basis of the job, and thus, protection of confidentiality can be achieved.

According to the present invention, identification of a user is carried out as a process for protecting the confidentiality of image data, when image formation is carried out. Accordingly, in the case where the user requires protection of confidentiality and a process for protecting the confidentiality can be implemented in the image forming apparatus, identification of the user is carried out when image formation is carried out, and thereby, protection of confidentiality can be achieved.

According to the present invention, the history of the accepted job is stored as a process for protecting the confidentiality of image data. Accordingly, in the case where the user requires protection of confidentiality and the process for protecting the confidentiality can be implemented in the image forming apparatus, the history of the accepted job is recorded, and thus, protection of confidentiality can be achieved.

According to the present invention, in the case where the relaying apparatus receives a job that has been transmitted from a transmission apparatus, this relaying apparatus determines whether or not the confidentiality of image data that is included in the job should be protected, and in the case where it has been determined that the confidentiality should be protected, whether or not a process for protecting the confidentiality can be implemented is determined, and in the case where it has been determined that implementation is impossible, the transmission apparatus is notified to that effect. Accordingly, the user is notified before the job is carried out, under the circumstances where a process for protecting the confidentiality cannot be implemented, and the user can cancel the job, if necessary, or change the destination of transmission of the job. As a result of this, the level of protection of confidentiality can be maintained constant in the whole of the system.

According to the present invention, in the case where the relaying apparatus receives a job that has been transmitted from a transmission apparatus, this relaying apparatus determines whether or not the confidentiality of image data that is included in the job should be protected, and in the case where it has been determined that the confidentiality should be protected, an image forming apparatus where protection of confidentiality is possible is searched for, and the transmission apparatus is notified of the search result. Accordingly, in the case where an image forming apparatus which can implement a process concerning protection of confidentiality is connected to the relaying apparatus, the origin of transmission of the job is notified of the information on this image forming apparatus, and therefore, the user can change the destination of transmission of the job, if necessary. As a result of this, the level of protection of confidentiality can be maintained constant in the whole of the system.

According to the present invention, information concerning whether or not protection of the confidentiality of image data is required is included in the job, and whether or not the confidentiality of image data should be protected is determined on the basis of this information. Accordingly, the intention of the user in terms of whether or not protection of confidentiality is required can be faithfully reflected, and the level of protection of confidentiality can be maintained constant.

According to the present invention, the information concerning the apparatus configuration includes information concerning the existence of a means for protecting the confidentiality of image data. Accordingly, whether or not the process for protecting the confidentiality can be implemented is determined on the basis of this information, and only image forming apparatuses where protection of confidentiality is possible can be extracted.

According to the present invention, the information concerning the apparatus configuration includes information concerning the state of operation of a means for protecting the confidentiality of image data. Accordingly, whether or not the process for protecting the confidentiality can be implemented is determined on the basis of this information, and only image forming apparatuses where protection of confidentiality is possible can be extracted.

According to the present invention, in the case where a job that has been transmitted from a transmission apparatus is received, whether or not the confidentiality of image data that is included in this job should be protected is determined, and in the case where it has been determined that the confidentiality should be protected, whether or not a process for protecting the confidentiality can be implemented is determined, and in the case where it has been determined that implementation is impossible, the transmission apparatus is notified to that effect. Accordingly, the user is notified before the job is carried out, under the circumstances where the process for protecting the confidentiality cannot be implemented, and the user can cancel the job on the basis of this notification, or change the destination of transmission of the job.

According to the present invention, in the case where a job that has been transmitted from a transmission apparatus is received, whether or not the confidentiality of image data that is included in this job should be protected is determined, and in the case where it has been determined that the confidentiality should be protected, an image forming apparatus where protection of confidentiality is possible is searched, and the transmission apparatus is notified of the search result. Accordingly, in the case where an image forming apparatus which can implement a process concerning protection of confidentiality is connected to the relaying apparatus, the origin of transmission of the job is notified of the information on this image forming apparatus, and thereby, the user can change the destination of transmission of the job, if necessary. As a result of this, the level of protection of confidentiality in the whole of the system can be maintained constant.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic diagram showing the entire configuration of an image forming system that is constructed using an image forming apparatus according to the present invention;

FIGS. 2A and 2B are schematic diagrams showing an example of print setting screens generated by the printer driver when a print job is prepared by the external computer;

FIG. 3 is a conceptual diagram showing an example of a print job that is prepared by the printer driver;

FIG. 4 is a block diagram showing the internal configuration of the image forming apparatus;

FIG. 5 is a conceptual diagram showing an example of the system management table;

FIG. 6 is a flowchart explaining the procedure in a process that is executed by the image forming apparatus when a print job is received;

FIG. 7 is a flowchart explaining the procedure in a process that is executed by the image forming apparatus when a print job is received;

FIG. 8 is a schematic diagram showing the entire configuration of an image forming system according to the present invention;

FIG. 9 is a block diagram showing the internal configuration of the print server;

FIG. 10 is a flowchart explaining the procedure in a process that is executed by the print server when a print job is received;

FIG. 11 is a flowchart explaining the procedure in a process that is executed by the print server when a print job is received;

FIG. 12 is a schematic diagram showing an example of a detection-result-displaying screen that is displayed by the external computer when receiving a notification of the detection result; and

FIG. 13 is a flowchart explaining the procedure of the execution-determining-process of a security process.

### DETAILED DESCRIPTION OF THE INVENTION

In the following, the present invention is concretely described in reference to the drawings showing the embodiments thereof.

### EMBODIMENT 1

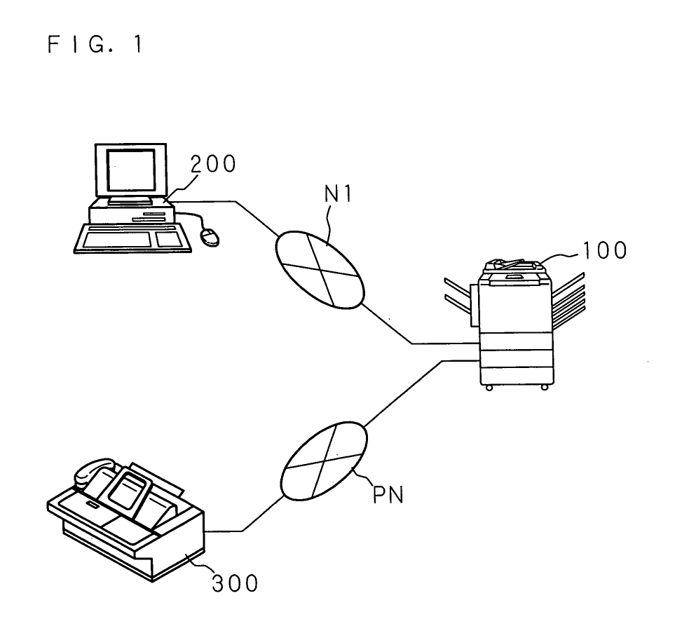

FIG. 1 is a schematic diagram showing the entire configuration of an image forming system that is constructed using an image forming apparatus according to the present invention. In the figure, 100 indicates an image forming apparatus according to the present invention, and an external computer 200 is connected to this image forming apparatus 100 via a communication network N1, such as a local area network, and an external facsimile apparatus 300 is connected via a public switched telephone network PN.

Application programs for preparing documents, graphics and the like, and a driver program (printer driver) for utilizing the image forming apparatus 100 via communication network N1 and the like are installed in advance in the external computer 200. A printer driver is called from an arbitrary application program, so that a print job that has been prepared by this printer driver is transmitted to the image forming apparatus 100, and thereby, a document, a graphic or the like is printed out.

An external facsimile apparatus 300 has a function of coding and decoding image data in accordance with a predetermined system, and can transmit and receive facsimile data that has been obtained by coding, via public switched telephone network PN. Namely, facsimile data that has been received via public switched telephone network PN is decoded, a print process is executed on the basis of the obtained image data and the image data that is to be transmitted is coded, and then, transmitted to image forming apparatus 100.

In the present embodiment, whether or not a process with regard to protection of the confidentiality at the time of preparation of a print job is required (hereinafter referred to as security process) can be set in order to protect the confidentiality of the contents (image data that becomes an object of printing output) that are to be printed out. The printer driver that has been installed in the external computer 200 makes information concerning whether or not a security process is required be included as a portion of header information in a print job which is transmitted to the image forming apparatus 100. The image forming apparatus 100 determines whether or not a security process is required at the time of reception of a print job from the external computer 200, and determines whether or not this security process can be executed in the case where the security process is required. The image forming apparatus 100 performs a print process only in the case where the security process can be executed, and cancels the print process in the case where the security process cannot be executed.

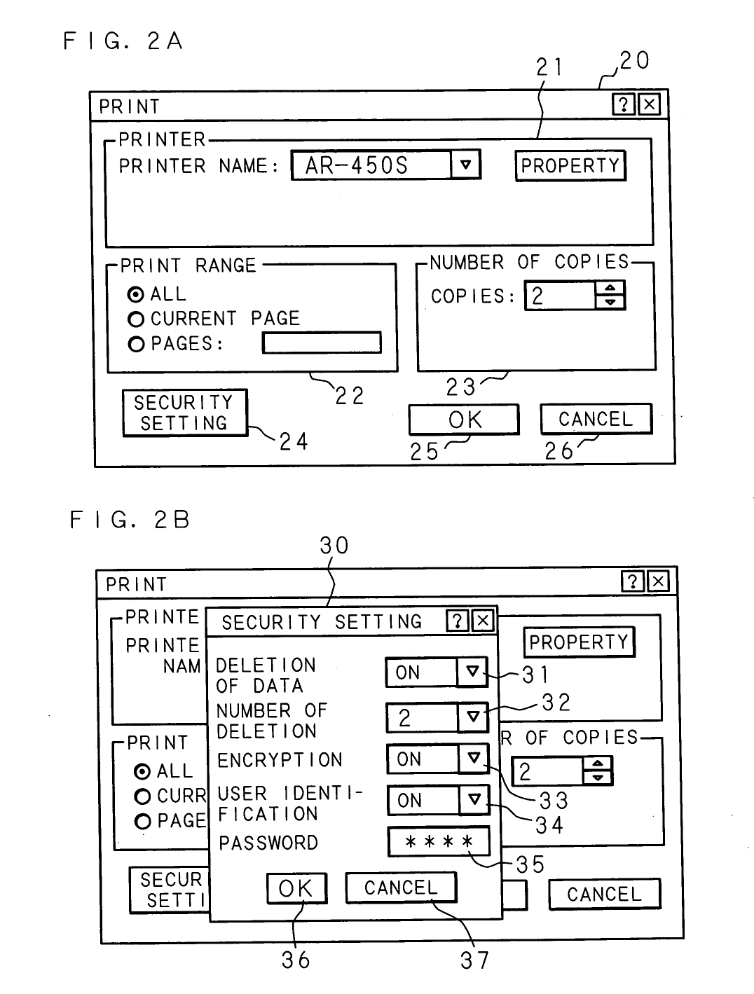

FIGS. 2A and 2B are schematic diagrams showing an example of print setting screens generated by the printer driver when a print job is prepared by the external computer 200. In the case where the printer driver is called from an arbitrary application program that has been started up in the external computer 200, the printer driver prepares a print setting screen 20, as shown in FIG. 2A, which is displayed on the display section (not shown) of the external computer 200. A printer designation column 21 which accepts designation of a printer (image forming apparatus) to which a print job is transmitted, a print range designation column 22 which accepts designation of a print range, and a designation column for the number of copies 23 which accepts the number of copies are displayed on print setting screen 20. A user can designate information that is required for a print process by operating a keyboard and a mouse, not shown.

A security setting button 24 is displayed beneath print range designation column 22, so that whether or not a security process is required can be set. In addition, an execution button 25 and a cancel button 26 are located to the right of the security setting button 24. In the case where the execution button 25 is selected, a print job of which the contents are designated or set by this print setting screen 20 is prepared and transmitted to a target printer. Meanwhile, in the case where the cancel button 26 is selected, no print job is prepared, and the process returns to the application that has called print setting screen 20.

In addition, in the case where the security setting button 24 is pressed down in print setting screen 20, a security setting screen 30 as shown in FIG. 2B is displayed over the print setting screen 20. This security setting screen 30 accepts settings concerning a deletion process, an encryption process and a user identification process as a security process.

A variety of setting buttons 31 to 34 in the form of a pull-down menu, a password input column 35, a confirmation button 36 and a cancel button 37 are displayed on security setting screen 30. In the case where the confirmation button 36 is pressed down, the setting items that have been selected through setting buttons 31 to 34, and the password that has been inputted in the password input column 35 are confirmed. Meanwhile, in the case where cancel button 37 is pressed down, a process for returning to print setting screen 20 is performed without confirming the setting.

In the following, the setting contents on the security setting screen 30 are described. The setting button 31 accepts the setting of whether or not a deletion process is required (on or off), and the setting button 32 accepts the setting of a number of deletions (1 to 9) in the deletion process. In a case where a deletion process and a number of deletions are set through these setting buttons 31 and 32, and a print job is transmitted to the image forming apparatus 100, the deletion process is executed as a security process, after it has been confirmed in the image forming apparatus 100 that the deletion process can be executed. In the deletion process, a print process is performed on the basis of the print job, and after that, the received print job and the image data that is developed from this print job are deleted. The deletion of the print job and the image data is executed by writing over zeros or random data, and the number of overwriting is set as the number of deletions.

The setting button 33 accepts setting of whether or not an encryption process is required (on or off). In the case where an encryption process is set through this setting button 33 and a print job is transmitted to the image forming apparatus 100, the encryption process is executed as a security process, after it has been confirmed in the image forming apparatus 100 that the encryption process can be executed. In the encryption process, a process for encrypting data that is handled in the image forming apparatus 100 (print job and image data that is developed from the print job) is carried out.

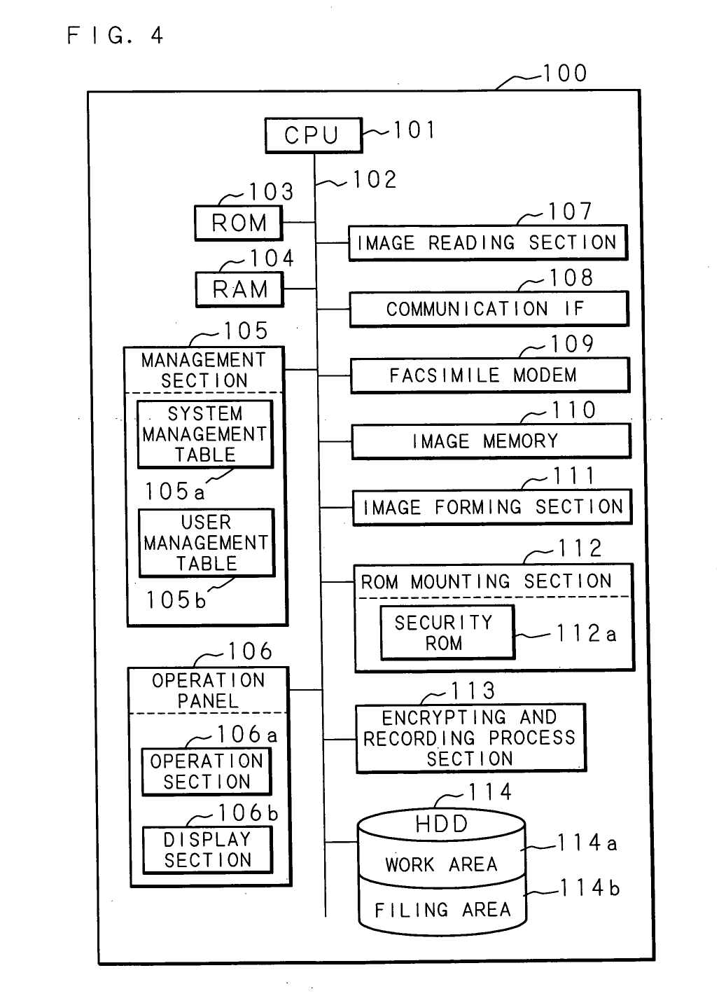

The setting button 34 accepts setting of whether or not user identification is required (on or off), and the password input column 35 accepts a password for user identification. In the case where a print job is transmitted after a user identification process has been set through the setting button 34 and the password has been inputted into the password input column 35, a user identification process is performed as a security process, after it has been confirmed in image forming apparatus 100 that the user identification process can be performed. In the user identification process, the print process is not performed at the time of reception, and the process is performed after the user identification is performed through an operation panel 106 (see FIG. 4) of the image forming apparatus 100.

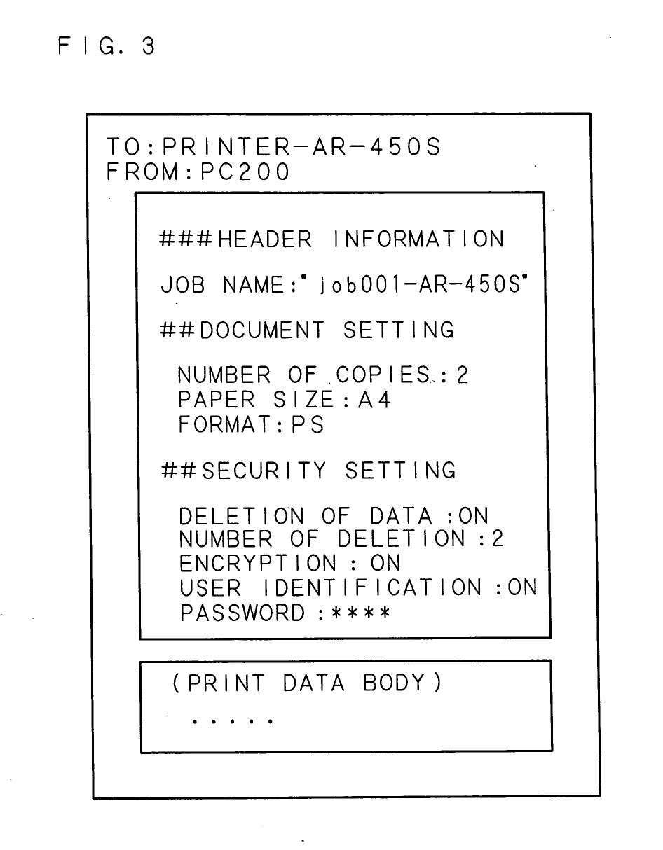

The printer driver that has been installed in the external computer 200 prepares a print job by making the setting contents that have been set as described above be included in header information. FIG. 3 is a conceptual diagram showing an example of a print job that is prepared by the printer driver. The print job is roughly divided into header information and print data body (image data). The header information includes a variety of items that have been set by the printer driver. Items which are included in the header information include an item concerning a number of copies, an item concerning the size of the paper, an item concerning the format of the print data body, and in addition, an item concerning the above described security setting. In addition, the print data body is formed of data which describes documents, graphics and the like that have been prepared through an arbitrary application, in a predetermined format.

In the case where the image forming apparatus 100 receives such a print job, image formation is performed on the basis of this image data, after it has been determined whether or not a security process is required and whether or not the security process can be performed. FIG. 4 is a block diagram showing the internal configuration of the image forming apparatus 100. Image forming apparatus 100 is provided with a CPU 101, and this CPU 101 loads a control program that has been stored in advance in a ROM 103 in a RAM 104, and executes the control program, and thereby, various types of hardware connected via a bus 102 are controlled, and the entire system is operated as an image forming apparatus related to the present invention.

In the following, the configuration of various types of hardware which are connected to bus 102 is described. A management section 105 is formed of a non-volatile semiconductor memory, and a part of this memory area is utilized as a system management table 105a for storing information concerning the configuration of its own apparatus, information concerning the state of operation of each piece of hardware and the like, and a user management table 105b for storing information concerning a user.

An operation panel 106 is formed of an operation section 106a that accepts operations by a user, and a display section 106b for displaying information that should be reported to a user. The operation section 106a is provided with various types of operation keys, numeral keys and the like for accepting settings of switching operation of functions, a number of outputted prints in a print process, magnification in a copying process, destination of transmission in a facsimile transmission process and the like. The display section 106b is provided with a liquid crystal displaying apparatus, and displays the state of operation of image forming apparatus 100, the set values that have been inputted from the operation section 106a and the like. In addition, a portion of the display section 106b is provided with software keys in a touch panel system which accepts a variety of selection operations through pressing operations by a user.

An image reading section 107 is provided with a light source for illuminating a manuscript to be read with light, an image sensor, such as a CCD (charge coupled device), an AD converter and the like (not shown), where the image of a manuscript that has been set in a predetermined reading position is formed on this image sensor so as to be converted to an analog electrical signal and the gained analog electrical signal is AD converted by the AD converter. Then, correction of unevenness in the light delivering characteristics of the light source at the time of reading of a manuscript, in the sensitivity of the image sensor and the like is carried out on a digital signal that has been gained as a result of AD conversion, and thereby, image data is generated in digital form.

A communication IF 108 is provided with a communication interface, in conformity with the communication standard of connection network N1, so that external computer 200 can be connected. The communication IF 108 receives a print job from the external computer 200 that is connected, and contrarily, transmits information of which the receiver should be notified. The communication IF 108 controls transmission and reception of these various types of data.

A facsimile modem 109 is provided with a line terminal circuit for connecting an external facsimile apparatus, and performs transmission and reception of facsimile data via the public switched telephone network. Therefore, facsimile modem 109 is provided with a decoding circuit for decoding facsimile data that has been received, and a coding circuit for coding facsimile data that is to be transmitted. Facsimile modem 109 performs such transmission and reception of facsimile data, and carries out a coding process and a decoding process.

An image memory 110 is formed of a semiconductor memory and temporarily stores image data that has been prepared by reading an image of a manuscript by means of the image reading section 107, image data that has been developed from a print job, and image data that has been data from facsimile data. Image data that has been temporarily stored in the image memory 110 is transferred to the destination of the transfer in accordance with the purpose of use in accordance with an indication by CPU 101. Namely, image data is transferred to an image forming section 111 in the case where an image is formed on a sheet of paper, is transferred to the facsimile modem 109 in the case where it is transmitted as facsimile data, and is transferred to an HDD 114 in the case where it is stored using a filing function.

The image forming section 111 forms an image on a sheet of paper on the basis of image data that has been transferred from the image memory 110. Therefore, the image forming section 111 is provided with an electrifier for charging a photosensitive drum to a predetermined potential, a laser writing apparatus for emitting a laser beam in accordance with image data that has been accepted from the outside and for forming an electrostatic latent image on the photosensitive drum, a developer for forming an image by supplying toner on the electrostatic latent image that has been formed on the surface of the photosensitive drum, and a transcriber for transcribing a toner image that has been formed on the surface of the photosensitive drum onto a sheet of paper, and forms an image desired by a user on a sheet of paper in an electronic photography system. Here, an image may be formed in the configuration, in an inkjet system, in a thermal transcription system, in a sublimation system or the like, instead of in an electronic photography system using a laser writing apparatus.

A ROM mounting section 112 is provided with a slot for mounting a security ROM 112a (protective device), and a detection circuit for detecting security ROM 112a that has been mounted into this slot. In the present image forming apparatus 100, the deletion process and the encryption process become effective at the point in time when the security ROM 112a is mounted on the ROM mounting section 112. Namely, in the case where the security ROM 112a is mounted, CPU 101 loads the computer program that has been stored in advance in this security ROM 112a in a RAM 104, and executes the computer program, and thereby, the security process for the data that is internally handled is made effective, and the deletion process and the encryption process are executed for a print job that has been received and an image data that is developed from this print job.

Here, though the present embodiment provides a configuration where the security ROM 112a is externally mounted on the ROM mounting section 112, it may provide a configuration wherein the state where the above described security function does not operate is provided as the default, and the state of default is released so that the security function operates, in the case where a predetermined key operation is accepted through the operation panel 106.

An encrypting and decoding process section 113 encrypts data that is stored in HDD 114 and decodes data that is read out from HDD 114. Therefore, the encrypting and decoding process section 113 is formed of an input buffer for inputting data that is to be encrypted or decoded, an operator for executing an operation process made of a predetermined encryption algorithm on data that has been set in the input buffer, and an output buffer for holding the operation result from the operator. Data to be encrypted or data to be decoded is inputted into the input buffer. The operator executes the operation process on input data that has been set in the input buffer and taken out, and this operation result is written into the output buffer at the stage where the operation process has been completed. CPU 101 takes out the data on which the operation has been completed from the output buffer, and thereby, obtains data that has been encrypted or decoded by the encrypting and decoding process section 113.

HDD 114 is a hard disk drive having hard disk controller and a magnetic recording medium in disk form. CPU 101 provides an instruction to the hard disk controller, and thereby, a write-in process and a read-out process of data are carried out. A portion of the memory area of HDD 114 is utilized as a data area for storing image data and the like, and image data that has been stored in the data area is read out in the case where a request is accepted through the operation panel 106 or in the case where a request from the external computer 200 is received via communication IF 108. Therefore, a print process can be performed by arbitrarily reading out image data that has been stored in the data area, in the case where it is necessary to re-implement the print process due to a failure in the print process or a shortage in the number of prints.

This data area is divided into a working area 114a and a filing area 114b, and the capacity of the working area 114 has been set so as to be small, as compared with that of the filing area 114b. Therefore, working area 114a is mainly utilized as an area for temporarily storing data that is being worked on, and data is automatically stored in the filing area 114b after a constant period of time has elapsed after being stored in the working area 114a, in the case where the amount of vacant capacity in the working area 114a becomes small. Meanwhile, the filing area 114b is an area for storing data after sorting the data in file formats, in process modes, such as printer function, scanner function, copy function and facsimile function, or in folders prepared by a user, and is in the state of being stored as long as no instruction, such as deletion, is carried out.

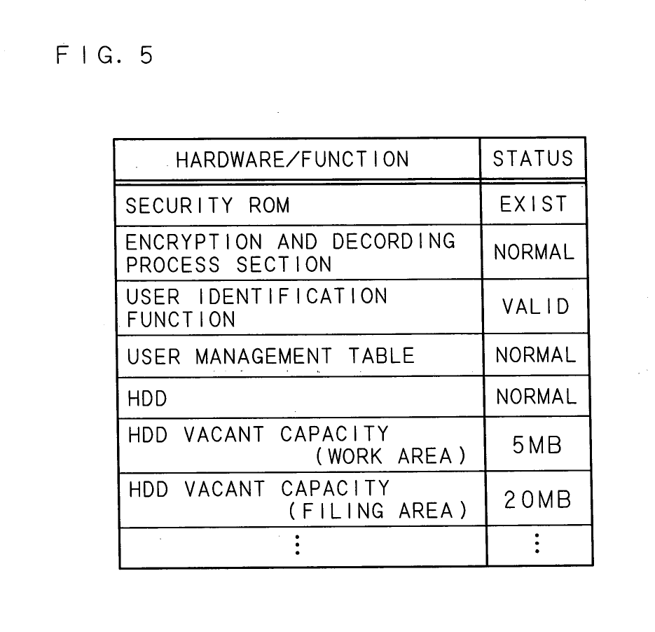

FIG. 5 is a conceptual diagram showing an example of system management table 105a. The system management table 105a manages information concerning the configuration of the apparatus, information concerning the existence of functions, information concerning the state of operation of each of the hardware and the like. The existence of a mounted the security ROM 112a, the state of operation of the encrypting and decoding process section 113, the state of operation of the user identification function, the state of recording of the user management table 105b, the state of operation of HDD 114, the vacant capacity of HDD 114 and the like can be cited as information that is managed by the system management table 105a. CPU 101 of the image forming apparatus 100 carries out communication with each of the hardware via the bus 102, and thereby, these pieces of information can be obtained whenever necessary, and the contents recorded in the system management table 105a can be updated if necessary in the configuration.

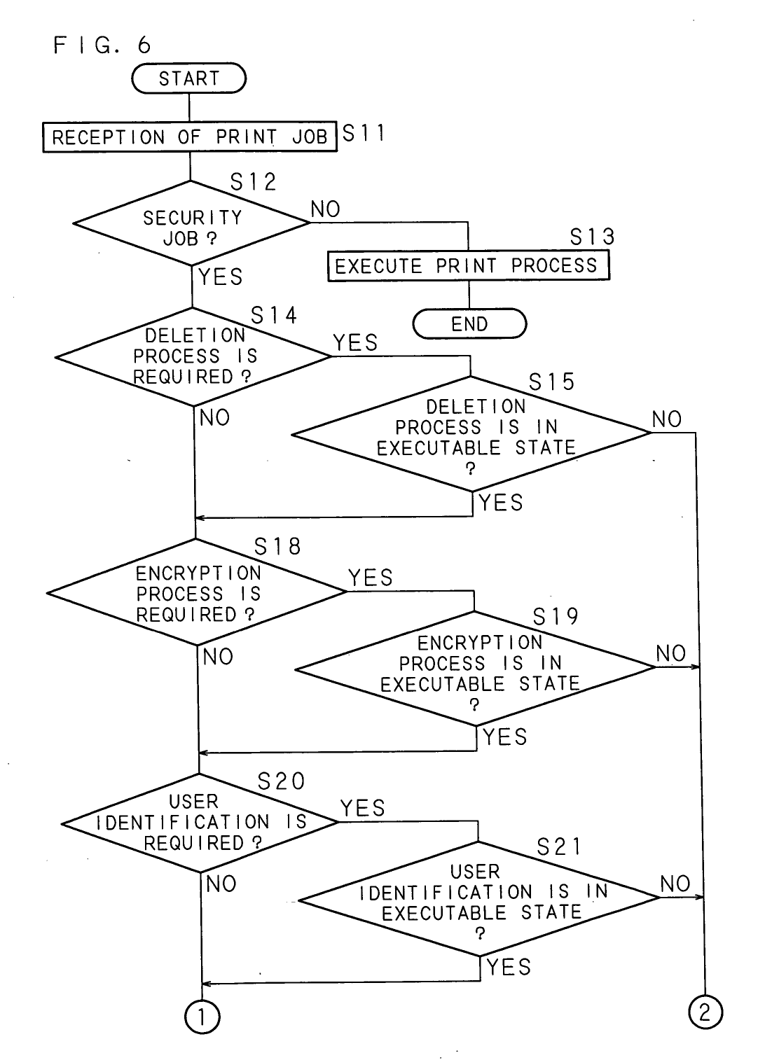

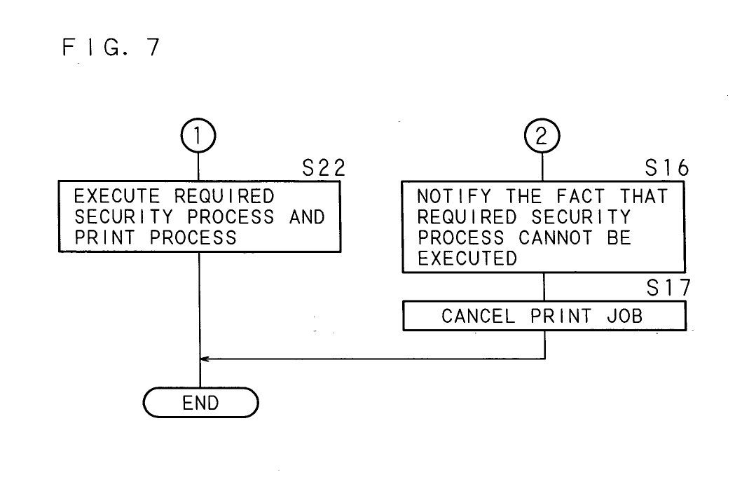

FIGS. 6 and 7 are a flowchart explaining the procedure in a process that is executed by the image forming apparatus 100 when a print job is received. In the case where a print job that has been transmitted from the external computer 200 is received through the communication IF 108 (Step S11), CPU 101 determines whether or not the received print job is a security job (Step S12). The determination of whether or not the received print job is a security job is carried out on the basis of the items concerning the security settings which are included in the header information of the print job. In the present embodiment, it is determined to be a security job in the case where any of a deletion process, an encryption process and user identification has been set.

In the case where it has been determined not to be a security job (NO in S12), image data that is developed from the print job is transferred to the image forming section 111 via the image memory 110, and thereby, a print process is performed (Step S13).

In the case where it has been determined to be a security job (YES in S12), CPU 101 determines whether or not the item of deletion of data in the header information of the print job has been turned on, and thereby, determines whether or not a deletion process is required (Step S14). In the case where a deletion process is required (YES in S14), CPU 101 refers to the system management table 105a, and thereby, determines whether or not the system is in the state where the deletion process can be determined that the security ROM 112a is not mounted on the ROM mounting section 112 as a result of the reference to the system management table 105a, the deletion process is invalidated, and therefore, it can be determined that the system is in the condition where the deletion process cannot be executed. In addition, in the case where it has been determined that HDD 114 is not operating normally as a result of the reference to the system management table 105a, there is a risk that the data that has been stored in HDD 114 cannot be deleted, and therefore, it can be determined that the system is in the state where the deletion process cannot be executed.

In the case where it has been determined that the system is not in the state where the deletion process can be executed (NO in S15), CPU 101 notifies the external computer 200 of the fact that the required security process cannot be executed (Step S16). Then, CPU 101 cancels the process that has been instructed by the received print job in Step S11 (Step S17).

In the case where it has been determined that the deletion process is not required in Step S14 (NO in S14), or in the case where it has been determined that the system is in the state where a deletion process can be executed in Step S15 (YES in S15), CPU 101 determines whether or not an encryption process is required, by determining whether or not the item of encryption in the header information in the print job has been turned on (Step S18). In the case where it has been determined that the encryption process is required (YES in S18), CPU 101 refers to the system management table 105a, and thereby, determines whether or not the system is in the state where the encryption process can be executed (Step S19). In the case where, for example, it has been determined that the security ROM 112a is not mounted on the ROM mounting section 112 as a result of the reference to the system management table 105a, the encryption process is invalidated, and therefore, it can be determined that the system is in the state where the encryption process cannot be executed. In addition, in the case where it has been determined that the encrypting and decoding process section 113 is not operating normally as a result of the reference to the system management table 105a, there is a risk that encryption of data may not be carried out, and therefore, it can be determined that the system is in the state where the encryption process cannot be executed.

In the case where it has been determined that the system is not in the state where the encryption process can be implemented (NO in S19), CPU 101 notifies the external computer 200 of the fact that the required security process cannot be executed (S16). Then, CPU 101 cancels the process that has been instructed by the received print job in Step S11 (S17).

In the case where it has been determined that the encryption process is not required in Step S18 (NO in S18), or in the case where it has been determined that the system is in the state where the encryption process can be executed in Step S19 (YES in S19), CPU 101 determines whether or not a user identification process is required, by determining whether or not the item of user identification has been turned on in the header information of the print job (Step S20). In the case where it has been determined that a user identification process is required (YES in S20), CPU 101 determines whether or not the system is in the state where a user identification process can be executed, by referring to the system management table 105a (Step S21). In the case where, for example, it has been determined that the user identification function has been invalidated as a result of the reference to the system management table 105a, it can be determined that the system is in the state where the user identification process cannot be implemented. In addition, in the case where there is no vacant capacity in HDD 114, the print job cannot be held until user identification has been carried out, and therefore, it can be determined that the system is in the state where the user identification process cannot be executed.

In the case where it has been determined that the system is in the state where the user identification process cannot be executed (NO in S21), CPU 101 notifies the external computer 200 of the fact that the required security process cannot be executed (S16). Then, CPU 101 cancels the process that has been instructed by the received print job in Step S11 (S17).

In the case where it has been determined that the user identification process is not required in Step S20 (NO in S20), or in the case where it has been determined that the system is in the state where the user identification process can be executed in Step S21 (YES in S21), CPU 101 executes the required security process and the print process (Step S22).

Here, though in the present embodiment, the execution of the print job is canceled in the configuration, in the case where a security process that is required by the external computer 200 cannot be executed in the image forming apparatus 100, a print process may be executed on the basis of the print job in the configuration, in the case where the user confirms whether or not forced execution is possible and forced execution is instructed a the time of the above described notification in Step S16.

In addition, though in the present embodiment, it has been determined whether or not a deletion process, an encryption process and a user identification process can be executed as a security process in the configuration, the security process is not necessarily limited to these, but rather, it may be determined in the configuration, for example, whether or not an identification process of the print job itself, a history management process of the print job or the like can be implemented.

### EMBODIMENT 2

Though in Embodiment 1, the image forming apparatus 100 that has received a print job from the external computer 200 determines whether or not a security process can be executed in the configuration, a print server may determine whether or not a security process can be executed before a print job is transferred to the image forming apparatus in the case where the system is constructed using the print server. constructed using the print server.

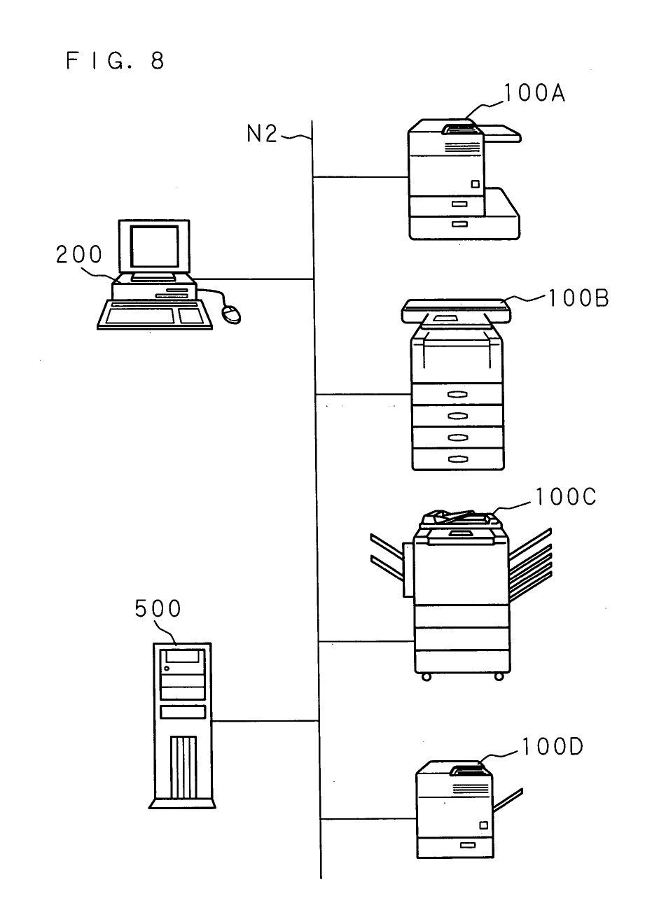

FIG. 8 is a schematic diagram showing the entire configuration of an image forming system according to the present invention. In the figure, 500 indicates a print server as a relaying apparatus according to the present invention, and image forming apparatuses 100A to 100D and an external computer 200 are connected to this print server 500 via communication network N2, which is, for example, a local area network.

The external computer 200 is the same as that described in Embodiment 1, and can execute a print process by preparing a print job using a printer driver that is installed in this external computer 200, and transmitting the print job to any of image forming apparatuses 100A to 100D via the print server 500.

The print server 500 periodically obtains information concerning the hardware configuration of the image forming apparatuses 100A to 100D (hereinafter referred to as hardware configuration information). This hardware configuration information is information that corresponds to the system management table 105a which is described in Embodiment 1, and includes information such as the existence of a security ROM, whether or not operation of an encrypting and decoding process section is possible, the existence of user identification functions and the like. In the case where the print server 500 receives a print job that has been transmitted from the external computer 200, an image forming apparatus which can execute a security process that has been designated is detected on the basis of the hardware configuration information, and the detection result is transmitted to the external computer 200. Then, in the case where one image forming apparatus which can execute a security process is selected by the external computer 200, the print job is transferred to this image forming apparatus in the configuration.

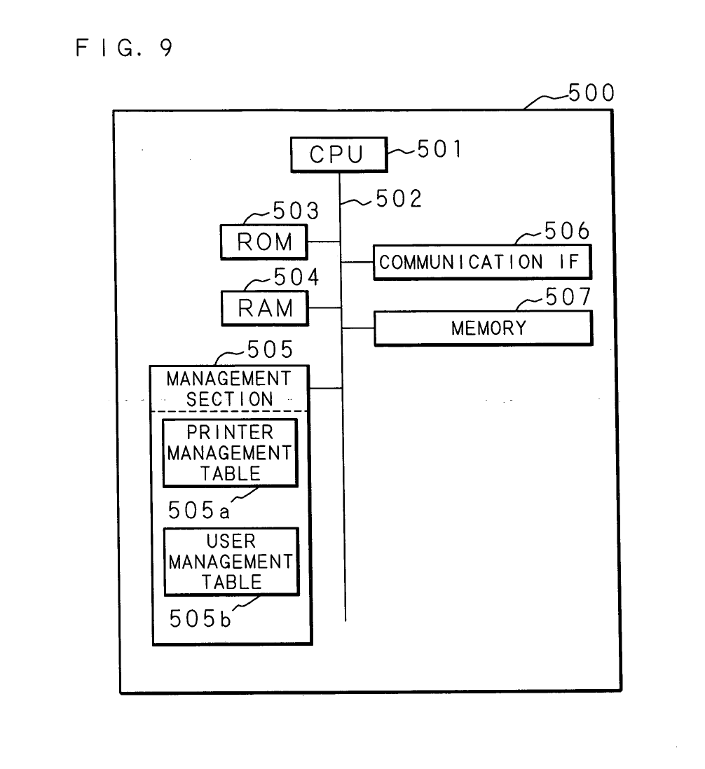

FIG. 9 is a block diagram showing the internal configuration of the print server 500. The print server 500 is provided with a CPU 501, and this CPU 501 loads a control program that has been stored in advance in a ROM 503 in a RAM 504 and executes the control program, and thereby, the hardware that is connected via bus 502 is controlled and the entire system operates as a relaying apparatus according to the present invention.

A management section 505 is formed of a non-volatile semiconductor memory, and a part of this memory area is utilized as a printer management table 505a for managing hardware configuration information on respective image forming apparatuses 100A to 100D, and a user management table 505b for storing information concerning a user. The print server 500 periodically obtains hardware configuration information on respective image forming apparatuses 100A to 100D, and updates the printer management table 505a.

A communication IF 506 (receiver unit) is provided with a communication interface in compliance with the communication standard of communication network N2, and allows a connection to the image forming apparatuses 100A to 100D and the external computer 200. The communication IF 506 receives a print job from the external computer 200 which is connected, and contrarily, transmits information of which the receiver should be notified. In addition, the communication IF 506 transfers a print job to the information forming apparatuses 100A to 100D, and receives hardware configuration information that is transmitted from the image forming apparatuses 100A to 100D. The communication IF 506 controls transmission and reception of these various types of data.

A memory 507 is formed of a volatile or non-volatile semiconductor memory, and temporarily stores a print job or the like that has been received by the communication IF 506. In addition, a magnetic recording medium, such as an HDD, may, of course, be used instead of the semiconductor memory.

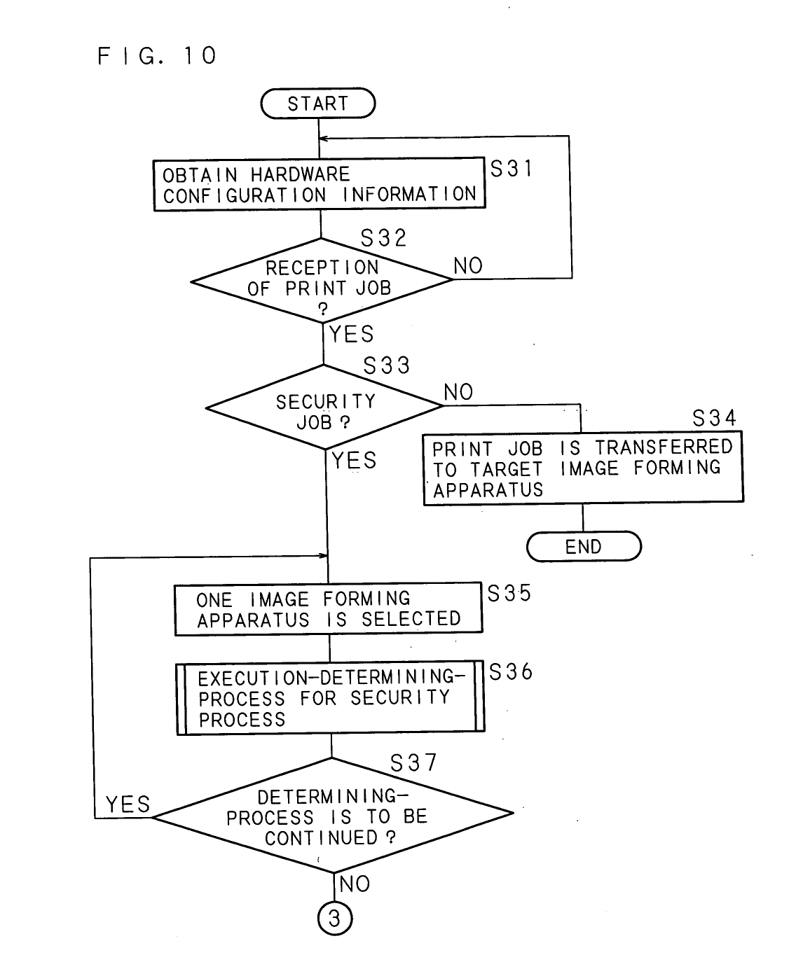

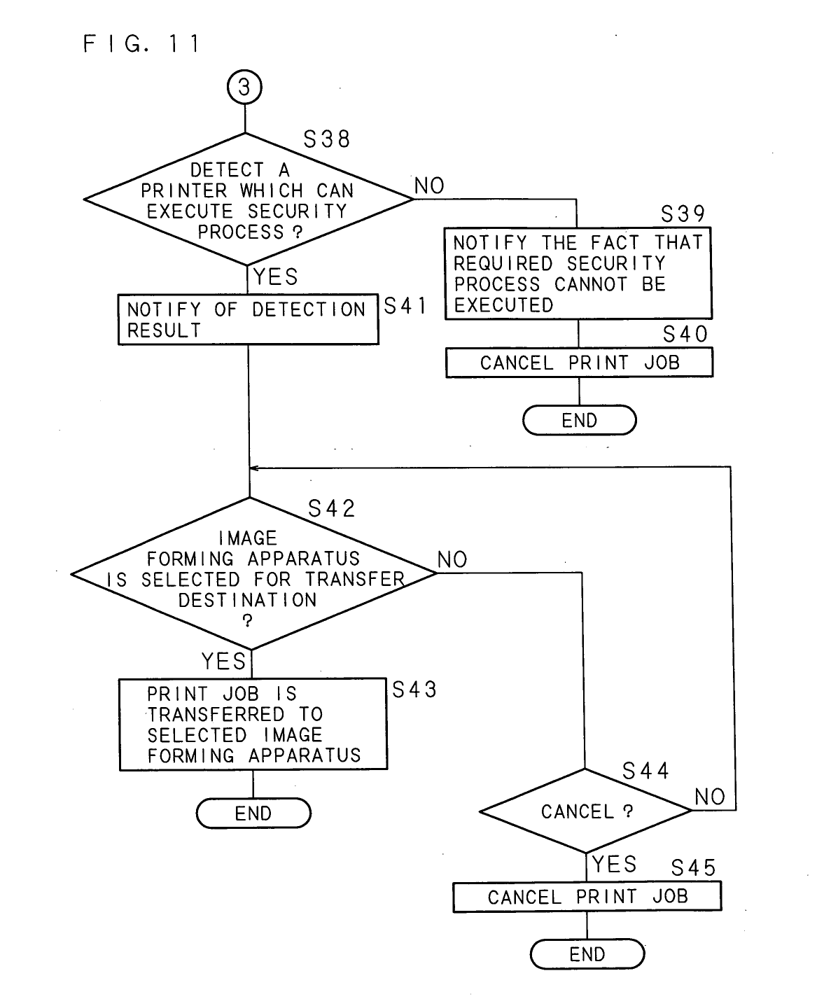

In the following, a process in the print server 500 is described. Here, in the following description, in the case where it is not necessary to distinguish between individual image forming apparatuses 100A to 100D, they are simply described as image forming apparatus 100. FIGS. 10 and 11 are a flowchart explaining the procedure in a process that is executed by the print server 500 when a print job is received. The print server 500 obtains a hardware configuration information of an image forming apparatus 100 prior to the reception of a print job (Step S31). Concretely speaking, the print server 500 periodically transmits a transmission request for hardware configuration information to the image forming apparatus 100, and receives the hardware configuration information that is transmitted from the image

Next, CPU 501 of the print server 500 determines whether or not a print job has been received through the communication IF 506 (Step S32). In the case where it has been determined that no print job has been received (NO in S32), the process is returned to Step S31.

In the case where it has been determined that a print job has been received (YES in S32), CPU 101 determines whether or not the received print job is a security job (Step S33). The determination of whether or not the print job is a security job is made based on the item concerning the security setting that is included in the header information of the print job. In the present embodiment, it is determined that the print job is a security job in the case where any of a deletion process, an encryption process and a user identification process has been set. In the case where it has been determined that the print job is not a security job (NO in S33), the print job is transferred to the target image forming apparatus 100 (Step S34).

In addition, in the case where it has been determined that the received print job is a security job (YES in S33), one image forming apparatus 100A (or 100B to 100D) is selected from among image forming apparatuses 100 which are managed by the printer management table 505a (Step S35), and an execution-determining-process for a security process is performed (Step S36). In the execution-determining-process for a security process, it is determined, on the basis of the hardware configuration information on the selected image forming apparatus 100A (or 100B to 100D), whether or not a security process that has been designated by the print job can be executed. Here, the detailed procedure of this determining process is described below.

Next, CPU 501 determines whether or not the determining-process is to be continued (Step S37). In the case where there is any image forming apparatus 100 where the execution-determining-process for a security process has not been completed, it is determined that the determining-process is to be continued (YES in S37) and CPU 501 returns the process to Step S35.

In the case where it has been determined that the determining-process is not to be continued (NO in S37), CPU 501 determines whether or not an image forming apparatus 100 which can execute the security process that has been required by the print job has been detected (Step S38). In the case where image forming apparatus 100 which can execute the required security process cannot be detected (NO in S38), the external computer 200 is notified to the fact that the required security process cannot be executed (Step S39) and the print job that was received in Step S32 is canceled (Step S40).

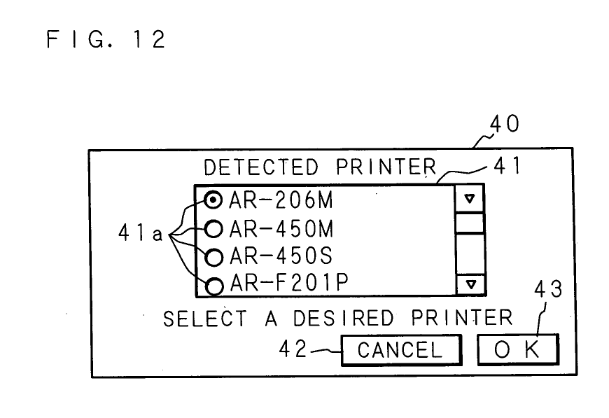

In the case where it has been determined that an image forming apparatus 100 which can execute the security process that has been required by the print job has been detected in Step S38 (YES in S38), the external computer 200 is notified of the detection result (Step S41). The external computer 200 which has received the notification of the detection result makes its own displaying apparatus display the detection result. FIG. 12 is a schematic apparatus display the detection result. FIG. 12 is a schematic diagram showing an example of a detection-result-displaying screen that is displayed by the external computer 200 when receiving the notification of the detection result. A display column 41 for displaying a list of the detection result, a cancel button 42 and an execution button 43 are displayed on detection-result-displaying screen 40, shown in FIG. 12. The names of the detected image forming apparatuses 100 are displayed in the display column 41, and at the same time, radio buttons 41a, 41a, . . . , 41a corresponding to the names of the displayed the image forming apparatuses 100 are displayed. A user selects one radio button 41a, and thereby, can select a print process. In addition, in the case where the cancel button 42 is pressed down, the external computer 200 notifies the print server 500 to the fact that the selection is canceled, while in the case where the execution button 43 is pressed down, the selection by the user is confirmed and the external computer 200 notifies the print server 500 of the result of the selection.

Then, CPU 501 of the print server 500 determines, on the basis of the notification from the external computer 200, whether or not the image forming apparatus 100 which is the destination of transfer, has been selected (Step S42). In the case where it has been determined that the image forming apparatus 100 which is the destination of transfer has been selected (YES in S42), the print job is transferred to the selected image forming apparatus 100 (Step S43).

In addition, in the case where it has been determined that the image forming apparatus 100 which is the destination of transfer has not been selected (NO in S42), it is determined whether or not the selection of the image forming apparatus 100 has been canceled (Step S44). In the case where it has been determined that the selection has not been canceled (NO in S44), CPU 501 returns the process to Step S42, and in the case where it has been determined that the selection has been canceled (YES in S44) CPU 501 cancels the print job (Step S45).

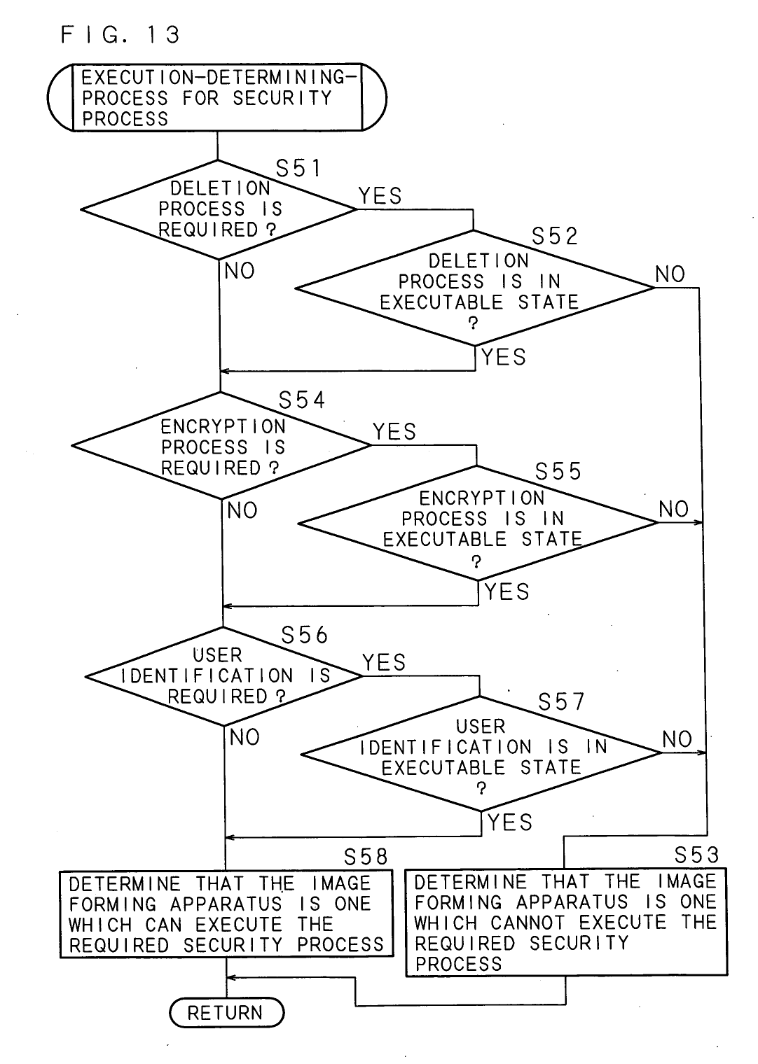

FIG. 13 is a flowchart explaining the procedure of the execution-determining-process of a security process. At first, CPU 501 of the print server 500 determines whether or not the print job that has been received in Step S32 requires a deletion process (Step S51). Whether or not the deletion process is required can be determined by referring to the item of the security setting that is included in the header information of the print job.

In the case where it has been determined that the deletion process is required (YES in S51), CPU 501 determines whether or not the image forming apparatus 100 that has been selected in Step S35 is in the state where the deletion process can be executed (Step S52). The hardware configuration information related to the information apparatus 100 is read out from printer management table 505a, and determination of whether or not a security ROM has been mounted and determination as to whether or not the HDD is operating normally are made, and thereby, whether or not the system is in the state where the deletion process can be implemented can be determined. In the case where the system is in S52), CPU 501 determines that the image forming apparatus 100 is one which cannot execute the required security process (Step S53).

In the case where it has been determined that the deletion process is not required in Step S51 (NO in S51), or in the case where it has been determined that the system is in the state where the deletion process can be executed in Step S52 (YES in S52), CPU 501 determines whether or not an encryption process is required by referring to the item of the security setting that is included in the header information of the print job (Step S54). In the case where it has been determined that the encryption process is required (YES in S54), CPU 501 determines whether or not the system is in the state where the image forming apparatus 100 that has been selected in Step S35 can execute the encryption process (Step S55). The hardware configuration information of the corresponding the image forming apparatus 100 is read out from the printer management table 505a, and a determination of whether or not a security ROM is mounted, as well as determination of whether or not the encrypting and decoding process section is operating normally, is made, and thereby, whether or not the system is in the state where an encryption process can be implemented can be determined. In the case where it has been determined that the system is not in the state where the encryption process can be executed (NO in S55), CPU 501 determines that the image formation apparatus 100 is one which cannot execute the required security process (S53).

In the case where it has been determined that the encryption process is not required in Step S54 (NO in S54), or in the case where it has been determined that the system is in the state where the encryption process can be executed in Step S55 (YES in S55), CPU 501 determines whether or not a user identification process is required by referring to the item of the security setting that is included in the header information of the print job (Step S56). In the case where it has been determined that a user identification process is required (YES in S56), CPU 501 determines whether or not the system is in the state where the image forming apparatus 100 that has been selected in Step S35 can execute a user identification process (Step S57). The hardware configuration information on the corresponding the image forming apparatus 100 is read out form the printer management table 505a, and a determination of whether or not the user identification functions are effective, as well as determination of whether or not there is any vacant capacity in the HDD, is made, and thereby, a determination is made whether or not the system is in the state where the user identification process can be executed. In the case where it has been determined that the system is not in the state where a user identification process can be executed (NO in S57), CPU 501 determines that the image forming apparatus 100 is one which cannot execute the required security process (S53).

In addition, in the case where it has been determined that no user identification process is required in Step S56 (NO in S56), or in the case where it has been determined that the system is in the state where the user identification process can be executed in Step S57 (YES in S57), CPU 501 determines that the image forming apparatus 100 is one which can execute the required security process (Step S58).

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, intended to be embraced by the claims.

1. An image forming apparatus which accepts a job that includes image data and requires image formation based on the image data, and which performs image formation by performing the accepted job, comprising
a controller capable of performing operations of:
judging whether or not the confidentiality of image data included in an accepted job is to be protected;
judging whether or not a process for protecting the confidentiality of the image data can be performed, when the confidentiality is judged to be protected; and
when it is judged that the process cannot be performed, notifying the judgment result.

2. The image forming apparatus according to claim 1, wherein said job includes information concerning whether or not the confidentiality of image data is to be protected, and a judgment is made as to whether the confidentiality of the image data is to be protected, based on said information.

3. The image forming apparatus according to claim 1, said controller further capable of performing an operation of detecting the existence of a protective device for protecting the confidentiality of the image data,
wherein a judgment is made as to whether the process can be performed, based on the detected result.

4. The image forming apparatus according to claim 1, comprising a protective device for protecting the confidentiality of the image data,
wherein said controller further capable of performing an operation of detecting the operating conditions of the protective device, and
a judgment is made as to whether the process can be performed, based on the detected result.

5. The image forming apparatus according to claim 1, wherein the process is a process for encrypting the image data.

6. The image forming apparatus according to claim 1, wherein the process is a process for deleting the image data after the completion of image formation based on the image data.

7. The image forming apparatus according to claim 1, wherein the process is a process for identifying a user when performing image formation based on the image data.

8. The image forming apparatus according to claim 1, wherein the process is a process for storing a history of a job that has been accepted.

9. An image forming system comprising;
a transmitting apparatus;
a relaying apparatus; and
an image forming apparatus;
wherein said transmitting apparatus comprises;
a transmitting section for transmitting a job that includes image data and requires image formation based on the image data to said image forming apparatus via said relaying apparatus,
said image forming apparatus comprises;
a receiving section for receiving a job that is transmitted from said transmitting apparatus;
an image forming section for performing image formation by performing the received job; and
a transmitting section for transmitting information concerning the configuration of the apparatus to said relaying apparatus,
and said relaying apparatus comprises;
a receiving section for receiving information that is transmitted from said image forming apparatus, and a job that is transmitted from said transmitting apparatus; and
a controller capable of performing operations of:
judging whether or not the confidentiality of image data included in a received job is to be protected;
judging whether or not a process for protecting the confidentiality of the image data can be performed, when the confidentiality is judged to be protected; and
when it is judged that the process cannot be performed, transmitting the judgment result to said transmitting apparatus.

10. The image forming system according to claim 9, wherein said job includes information concerning whether or not the confidentiality of image data is to be protected, and a judgment is made as to whether the confidentiality of the image data is to be protected, based on said information.

11. The image forming system according to claim 9, wherein the information concerning the configuration of the apparatus includes information concerning the existence of a protective device for protecting the confidentiality of the image data.

12. The image forming system according to claim 9, wherein the information concerning the configuration of the apparatus includes information concerning the operating conditions of a protective device for protecting the confidentiality of the image data.

13. An image forming system comprising;
a transmitting apparatus;
a relaying apparatus; and
a plurality of image forming apparatuses;
wherein said transmitting apparatus comprises;
a transmitting section for transmitting a job that includes image data and requires image formation based on the image data to the image forming apparatus via said relaying apparatus,
said image forming apparatus comprises;
a receiving section for receiving a job that is transmitted from said transmitting apparatus;
an image forming section for performing image formation by performing the received job; and
a transmitting section for transmitting information concerning the configuration of the apparatus to said relaying apparatus,
and said relaying apparatus comprises;
a receiving section for receiving information that is transmitted from each image forming apparatus, and a job that is transmitted from said transmitting apparatus; and
a controller capable of performing operations of:
judging whether or not the confidentiality of image data included in a received job is to be protected;
searching for an image forming apparatus where protection of the confidentiality of the image data is possible, when the confidentiality is judged to be protected; and
notifying said transmitting apparatus of the searched result.

14. The image forming system according to claim 13, wherein said job includes information concerning whether or not the confidentiality of image data is to be protected, and a judgment is made as to whether the confidentiality of the image data is to be protected, based on said information.

15. The image forming system according to claim 13, wherein the information concerning the configuration of the apparatus includes information concerning the existence of a protective device for protecting the confidentiality of the image data.

16. The image forming system according to claim 13, wherein the information concerning the configuration of the apparatus includes information concerning the operating conditions of a protective device for protecting the confidentiality of the image data.

17. A relaying apparatus comprising;
a connecting section for connecting an image forming apparatus;
a receiving section for receiving a job that includes image data and requires image formation based on the image data, and information concerning the configuration of an image forming apparatus that is connected to the connecting section;
a transmitting section for transmitting a received job to the image forming section;
a controller capable of performing operations of:
judging whether or not the confidentiality of image data included in a received job is to be protected;
judging whether or not a process for protecting the confidentiality of the image data can be performed, when the confidentiality is judged to be protected; and
when it is judged that the process cannot be performed, transmitting the judgment result to the origin of the transmission of the job.

18. A relaying apparatus comprising;
a connecting section for connecting a plurality image forming apparatuses;
a receiving section for receiving a job that includes image data and requires image formation based on the image data, and information concerning the configuration of image forming apparatuses that are connected to the connecting section;
a transmitting section for transmitting a received job to an image forming section;
a controller capable of performing operations of:
judging whether or not the confidentiality of image data included in a received job is to be protected;
searching for an image forming apparatus where protection of the confidentiality of the image data is possible, when the confidentiality is judged to be protected; and
notifying the origin of the transmission of the job of the searched result.
